(19) United States
(12) Patent Application Publication
(10) Pub. No.: US 2024/0289634 A1
(43) Pub. Date: Aug. 29, 2024

(54) TRUST BASED FEDERATED LEARNING

(71) Applicant: Micron Technology, Inc., Boise, ID (US)

(72) Inventors: Shashank Bangalore Lakshman, Folsom, CA (US); Pavana Prakash, Houston, TX (US); Poorna Kale, Folsom, CA (US)

(21) Appl. No.: 18/439,217

(22) Filed: Feb. 12, 2024

Related U.S. Application Data
(60) Provisional application No. 63/448,521, filed on Feb. 27, 2023.

(51) Int. Cl. G06N 3/098; G06N 3/04

(52) U.S. Cl. CPC G06N 3/098; G06N 3/04

(57) ABSTRACT

Apparatuses and methods related to federated learning are described. A host system can, responsive to a valid trust signal from a first local device, communicate a global model and a global loss value to the local device. The host system can receive a local loss value from the local device. The local loss value can be based on execution of a local version of the global model, generated by the local device, on a local test dataset by the local device. The host system can analyze the local loss value based on quantities of training samples and test samples. Responsive to the local loss value being more preferred than the global loss value, the host system can receive the local version of the global model from the local device, update the global model, and communicate the updated global model to the local device and to another local device.

### CROSS-REFERENCE TO RELATED APPLICATION

This application claims the benefit of U.S. Provisional Application No. 63/448,521, filed on Feb. 27, 2023, the contents of which are incorporated herein by reference.

### TECHNICAL FIELD

The present disclosure relates generally to memory devices, and more particularly, to devices and methods related to trust based federated learning.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 illustrates an example computing system for trust based federated learning in accordance with some embodiments of the present disclosure.

FIG. 2 illustrates a flow diagram of trust based federated learning in accordance with a number of embodiments of the present disclosure.

FIG. 3 illustrates an example of a method for trust based federated learning in accordance with a number of embodiments of the present disclosure.

FIG. 4 illustrates an example machine of a computer system within which a set of instructions, for causing the machine to perform any one or more of the methodologies discussed herein, can be executed.

### DETAILED DESCRIPTION

The present disclosure includes apparatuses and methods related to federated learning. As used herein, “federated learning” refers to an approach to training an algorithm (e.g., a neural network) across multiple decentralized edge devices and/or servers (also referred to herein as local device) storing local datasets without exchanging the local datasets between the decentralized edge devices and/or servers. In contrast to other approaches in which local datasets are uploaded to a host system (e.g., a central server) or that assume identical distribution of the local datasets, federated learning can enable multiple actors (e.g., heterogeneous devices) to generate a common, robust machine learning model without sharing data between the local devices. As a result, critical issues, such as data privacy, data security, data access rights, and access to heterogeneous data, for example, can be addressed.

Federated learning can include a host system communicating (e.g., broadcasting) a global model to multiple heterogeneous devices (e.g., on a network). Local devices is also used herein to refer to heterogeneous devices. In federated learning, one or more local datasets are used to train and/or retrain the global model on the local devices. Local versions (e.g., trained versions) of the global model (also referred to herein as local models) are communicated (upstream) from one or more of the local devices to the host system. An updated global model is communicated (downstream) from the host system to the local devices. The communication of updates to a global model can include transmitting signals indicative of the entire updated global model or only updated portions of the global model (e.g., updated weights and biases). This process can be repeated until the global model has a desired loss value.

Some previous approaches to federated learning may yield models that are inferior relative to models generated by approaches that pool local datasets. Some previous approaches to federated learning may be vulnerable to untrustworthy local devices and malicious actors on the models. Stochasticity (random variability) of local models may increase (extend) how long some previous approaches take to optimize a global model (e.g., achieves a desired loss value) and/or increase the quantity and/or frequency of communication between the central server and local devices (upstream and/or downstream).

Embodiments of the present disclosure address the above deficiencies and other deficiencies of previous approaches by reducing communication of unnecessary local models to a host system. For instance, some embodiments include communication of respective local models from one or more local devices to a host system only in response to signaling from the host system indicative of requesting a local model. Embodiments of the present disclosure can reduce, or even minimize, a loss value of a global model (a global loss value) via analysis of local models in lesser time and/or with reduced resource consumption (e.g., reduced communication, computation, memory use, etc.).

As used herein, the singular forms “a,” “an,” and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

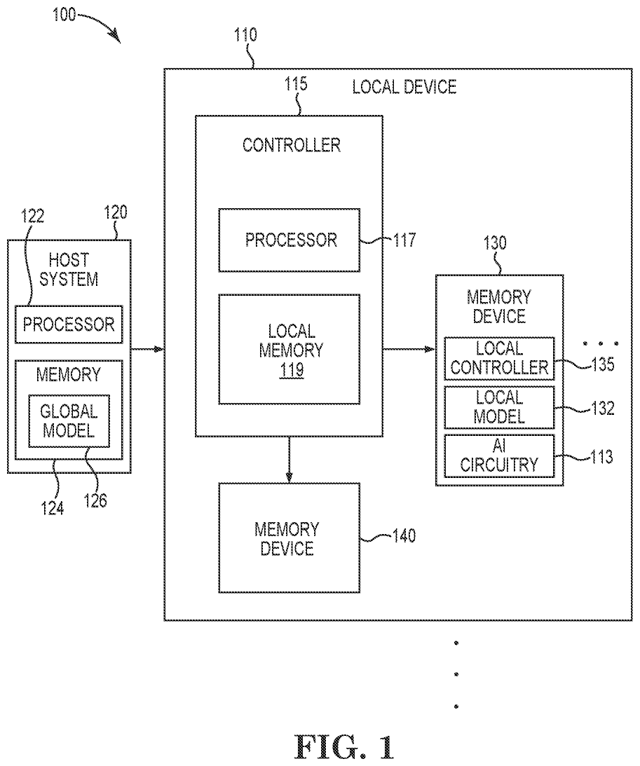

FIG. 1 illustrates an example computing system 100 for federated learning in accordance with some embodiments of the present disclosure. The computing system 100 can include a host system 120 and a local device 110 can include media, such as one or more volatile memory devices (e.g., memory device 140), one or more non-volatile memory devices (e.g., memory device 130), or a combination of such. Although FIG. 1 illustrates one example local device coupled to (e.g., in communication with) the host system 120, any quantity of local devices can be coupled to (e.g., in communication with) the host system 120. As used herein, the term “coupled to” or “coupled with” can refer to a connection between components, which can be an indirect communicative connection or direct communicative connection (e.g., without intervening components), whether wired or wireless, including connections such as electrical, optical, magnetic, etc. The local device 110, and other local devices, can be distinct from the host system 120.

The local device 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include the host system 120 that is coupled to one or more local devices, such as the local device 110. In some embodiments, the host system 120 is coupled to different types of local devices (heterogeneous devices). The host system 120 can include a processor 122 and a software stack (not shown) executed by the processing sub-system. The processor 122 can include one or more cores, one or more caches, a memory controller (e.g., NVDIMM controller), and a storage protocol controller (e.g., PCIe controller, SATA controller). The host system 120 can include a memory 124, in which a global model 126 can be stored.

The host system 120 can be coupled to the local device 110 via an interface (e.g., a physical interface and/or a wireless interface). Examples of a physical interface can include, but are not limited to, a serial advanced technology attachment (SATA) interface, a peripheral component interconnect express (PCIe) interface, universal serial bus (USB) interface, Fibre Channel, Small Computer System Interface (SCSI), Serial Attached SCSI (SAS), a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), Universal Serial Bus (USB), or any other physical interface. Examples of a wireless interface can include, but are not limited to, a cellular interface, a Wi-Fi interface, a Bluetooth interface, or any other wireless interface. The interface can be used to transmit data between the host system 120 and the local device 110. The host system 120 can further utilize an NVM Express (NVMe) interface to access memory components (e.g., memory devices 130) of the local device 110 when the local device 110 is coupled with the host system 120 by the PCIe interface. The interface can provide a way for passing control, address, data, and other signals between the local device 110 and the host system 120. The host system 120 can access multiple local devices via a same communication connection, multiple distinct communication connections, and/or a combination of communication connections.

The memory devices 130 and 140 can include any combination of the different types of non-volatile memory devices and/or volatile memory devices. The volatile memory devices (e.g., the memory device 140) can be, but are not limited to, random access memory (RAM), such as dynamic random access memory (DRAM) and synchronous dynamic random access memory (SDRAM).

Some examples of non-volatile memory devices (e.g., the memory device 130) include negative-and (NAND) type flash memory and write-in-place memory. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as NAND type memory (e.g., 2D NAND, 3D NAND) are described, the memory device 130 can be based on any other type of non-volatile memory or storage device, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A controller 115 of the local device 110 can communicate with the memory devices 130 to perform operations such as reading data, writing data, or erasing data at the memory devices 130 and other such operations. The controller 115 can include hardware such as one or more integrated circuits and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or other suitable processor.

The controller 115 can be a processing device, which includes one or more processors (e.g. processor 117), configured to execute instructions stored in a local memory 119. In the illustrated example, the local memory 119 of the controller 115 includes an embedded memory configured to store instructions for performing various processes, operations, logic flows, and routines that control operation of the local device 110, including handling communications between the local device 110 and the host system 120.

In some embodiments, the local memory 119 can include memory registers storing memory pointers, fetched data, etc. The local memory 119 can also include read-only memory (ROM) for storing micro-code. While the local device 110 described in association with FIG. 1 includes the controller 115, in at least one embodiment of the present disclosure, the local device 110 does not include the controller 115 and can rely upon external control (e.g., provided by an external host, or by a processor or controller distinct from the local device 110).

The controller 115 can receive commands or operations from the host system 120 and can convert the commands or operations into instructions or appropriate commands to achieve the desired access to the memory device 130 and/or the memory device 140. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The controller 115 can further include host interface (not shown) circuitry to communicate with the host system 120 via a physical host interface (not pictured). The host interface circuitry can convert the commands received from the host system into command instructions to access the memory device 130 and/or the memory device 140 as well as convert responses associated with the memory device 130 and/or the memory device 140 into information for the host system 120.

The local device 110 can also include additional circuitry or components that are not illustrated. In some embodiments, the local device 110 can include a cache or buffer (e.g., DRAM) and address circuitry (e.g., a row decoder and a column decoder) that can receive an address from the controller 115 and decode the address to access the memory device 130 and/or the memory device 140.

In some embodiments, the memory device 130 includes one or more local controllers 135 that operate in conjunction with the controller 115 to execute operations on one or more memory cells of the memory devices 130. An external controller (e.g., the controller 115) can externally manage the memory device 130 (e.g., perform media management operations on the memory device 130). In some embodiments, the memory device 130 is a managed memory device, which is a raw memory device combined with a local controller (e.g., the local controller 135) for media management within the same memory device package. An example of a managed memory device is a managed NAND (MNAND) device.

The host system 120 can be communicatively coupled (e.g., via a wireless interface) to the local device 110. The host system 120 can be distinct from one or more local devices. In some embodiments, the host system 120 can be a cloud server, or a component thereof.

The host system 120, or the processor 122, can receive a trust signal from the local device 110. The trust signal can be used to verify that the local device 110 is recognized and trusted by the host system 120 to ensure that the host system 120 only exchanges data with authorized (e.g., “trustworthy”) local devices. The trust signal can explicitly indicate a “need-to-update” the global model 126 to the local device 110. The host system 120 can determine whether a respective trust signal from a local device is valid (e.g., trust==true). In response to a valid trust signal from the local device 110, the host system 120 can communicate a global model (e.g., an initial version of the global model) and a global loss value (e.g., a global loss threshold) associated with the global model 126 to the local device 110. The host system 120 can receive a local loss value from the local device 110. The local loss value can be less than the global loss value. The local loss value can be based on execution of a trained version of the global model 126 (e.g., a local model 132) on a local test dataset by the local device 110. As described herein, the local model 132 can be generated by the local device 110 as a result of training the global model 126 by the local device 110.

The host system 120 can analyze a local loss value based on a quantity of (how many) training samples used by the local device 110 to train the global model 126 and/or a quantity of (how many) test samples (of the local test dataset) used to test the trained global model (the local model 132). Training the global model can include updating weights and/or biases of the global model based on iteratively executing the global model on the training dataset. After training the global model, the trained global model can be executed on a testing dataset obtained by the local device to validate the trained global model.

A local model that was tested using a greater quantity of samples than that used to test another local model (e.g., from another local device) can be more reliable. Local devices having greater experience (as indicated by the quantity of training samples and/or the quantity of test samples) can influence updates to a global model by a higher magnitude (e.g., perceived utility gain) than other local devices having lesser experience. In some embodiments, an aggregated trust score can be used to differentiate between reliable (trustworthy) local devices from unreliable or untrustworthy local devices.

A training dataset can be predetermined (e.g., stored in the local memory 119) and used by multiple local devices to train one or more global models. Analysis of a local loss value, by the host system 120, can include a determination of whether the local loss value is less than a different local loss value from another local device. A lower local loss value is preferred.

The analysis of a local loss value, by the host system 120, can indicate that the local loss value is more preferred than the global loss value. The local loss value can be preferred, over the global loss value, if, for instance, the local loss value: is less than the global loss value (e.g., by at least a particular amount), corresponds to a local model trained using at least a threshold quantity of training samples, corresponds to a local model trained using a greater quantity of training samples than one or more other local models from other local devices, corresponds to a local model tested using at least a threshold quantity of testing samples, and/or corresponds to a local model tested using a greater quantity of testing samples than one or more other local models from other local devices.

In response to a result of an analysis of a local loss value from the local device 110, by the host system 120, being indicative that the local loss value is more preferred than the global loss value, the host system 120 can communicate a trust signal to the local device 110. The trust signal communicated from the host system 120 to the local device 110 is different from the trust signal communicated from the local device 110 to the host system 120. However, the trust signal from the host system 120 can have similar purposes. The trust signal can be used to verify that the host system 120 is recognized and trusted by the local device 110. The trust signal can explicitly indicate a “need-to-update” the global model 126 from the host system 120. The trust signal communicated to the local device 110 is indicative of the host system 120 requesting the local model associated with the local loss value from the local device 110. If a different local loss value from a different local device is less than the local loss value, then the host system 120 can communicate a trust signal to that local device and receive a different local model therefrom. The different local model can be communicated from the host system 120 to one or more local devices, as described herein.

The host system 120 can receive the local model 132 from the local device 110 in response to communication of the trust signal to the local device 110. The host system 120 can update the global model 126 based on the local model 132, the local loss value, the quantity of training samples, and the quantity of test samples. The host system 120 can communicate the updated global model to the local device 110 and to one or more other local devices.

The local device 110 includes artificial intelligence (AI) circuitry 113. Although the AI circuitry 113 is illustrated as a component of the memory device 130, in some embodiments the AI circuitry 113 can be a different component of the local device 110, such as the controller 115. AI circuitry can be configured to combine data using iterative processing and algorithms such that the AI circuitry learns from patterns and/or features in the data. A non-limiting example of AI circuitry can be a neural network. As used herein, “neural network” refers to software, hardware, or combinations thereof configured to process data in a manner similar to neurons of a human brain. Artificial neural networks can include various technologies such as deep learning and machine learning. As used herein, “machine learning” refers to an ability software, hardware, or combinations thereof to learn and improve from experience without improvements being explicitly programmed. As used herein, “deep learning” refers to machine learning methods based on artificial neural networks with representation learning (also referred to herein as deep neural networks (DNNs)), which can be supervised, semi-supervised or unsupervised. Deep learning can be a subset of AI. The low power, inexpensive design of deep learning accelerators (DLAs) can be implemented in internet-of-things (IOT) devices. The DLAs can process and make intelligent decisions at run-time. Memory devices including the edge DLAs can also be deployed in remote locations without cloud or offloading capability.

The controller 115 can communicate a trust signal to the host system 120. In response to communication of the trust signal, the local device 110 can receive a global model (e.g., the global model 126) and a global loss value from the host system 120. The AI circuitry 113 can train the global model 126 using a dataset that is dedicated to training (e.g., a training dataset). The trained model is an updated version of the global model. The AI circuitry 113 can execute the trained global model using a different dataset (e.g., a testing dataset). The controller 115 can determine whether a local loss value associated with the local model 132 is less than the global loss value. In response to a determination that the local loss value is at most the global loss value, the controller 115 can communicate the local loss value and a quantity of samples of the testing dataset to the host system 120.

In response to a determination that the local loss value is greater than the global loss value, the controller 115 can cause the AI circuitry 113 to further train the global model 126 using the training dataset and execute the further trained global model using a different dataset (e.g., a different testing dataset). The further trained model is a different updated version of the global model. The controller 115 can determine whether a different loss value associated with execution of the further trained global model is at most the global loss value. In response to a determination that the different local loss value is at most the global loss value, the controller 115 can communicate the different local loss value and a quantity of samples of the different testing dataset to the host system 120.

As described herein, the controller 115 can receive a trust signal from the host system 120 and, in response to the trust signal, communicate the local model 132 to the host system 120. The controller 115 can determine whether the trust signal from the host system 120 is valid (e.g., trust==true) and communicate the local model 132 to the host system 120 in response to determining that the trust signal is valid.

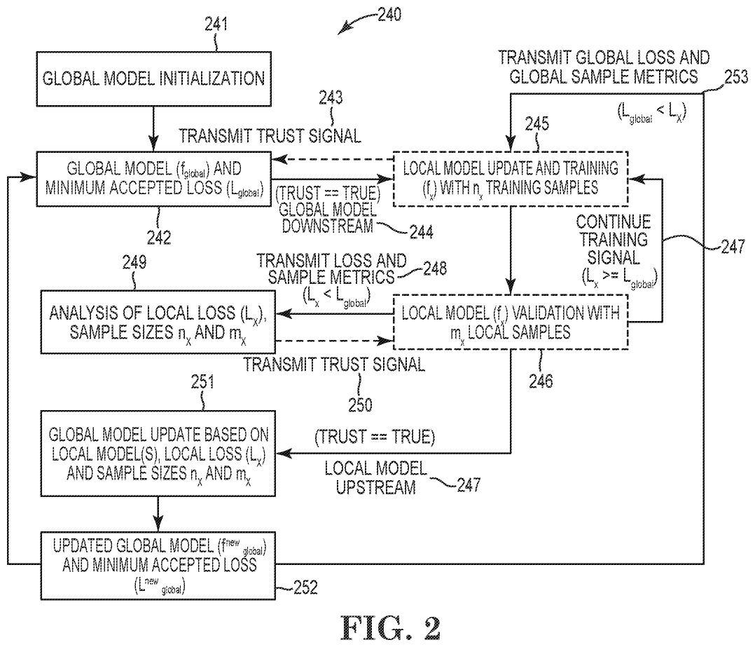

FIG. 2 illustrates a flow diagram 240 of federated learning in accordance with a number of embodiments of the present disclosure. Boxes with a solid outline correspond to actions that can performed by a host system, such as the host system 120 described in association with FIG. 1. Boxes with a dashed outline correspond to actions that can performed by one or more local devices, such as the local device 110.

At 241, a host system can perform global model initialization.

Global model initialization can include training the global model until at least a particular loss value is achieved. As illustrated at 242, the global model is referred to as f_{global} and the loss value from the global model initialization can be a global loss value (L_{global}). As described herein, at 243, a local device can communicate a trust signal to a host system. If the host system determines that the trust signal is valid (e.g., trust==true), then, at 244, the host system communicates the global model (f_{global}) and the global loss threshold (L_{global}) to that local device.

At 245, the local device trainings the global model, which yields a local model (fₓ where x identifies a particular local device). The training is performed using a training dataset where nₓ is a quantity of samples of the training dataset. Training the global model can include updating weights and/or biases of the global model. At 246, the local device tests (e.g., validates) the local model (fₓ) using a testing dataset where mₓ is a quantity of samples of the testing dataset. The testing dataset can be obtained by the local device, and may be unique to that local device. At 247, the local device determines whether a local loss value (Lₓ) from testing the local model (fₓ) is at most the global model value (L_{global}). If the local loss value (Lₓ) is greater than the global loss value (L_{global}), then the local device further trains the global model. If the local loss value (Lₓ) is at most the global model value (L_{global}), then, at 248, the local device communicates the local loss value (Lₓ), the quantity of samples (nₓ) of the training dataset, and the quantity of samples (mₓ) of the testing dataset to the host system.

As described in association with FIG. 1, at 249, the host system analyzes the local loss value (Lₓ) based on the quantity of samples (nₓ) of the training dataset and the quantity of samples (mₓ) of the testing dataset. In response to the analysis indicating that the local loss value (Lₓ) is preferred, at 250, the host system communicates a trust signal to the local device. In response to receipt of the trust signal from the host system, the local device, at 251, communicates the local model (fₓ) to the host system.

At 251, the host system performs an update to the global model based on one or more local models from trusted local devices and the corresponding quantities of samples (nₓ and mₓ) to yield, at 252, an updated (e.g., new) global model (f^{new}_{global}) and an updated (e.g., new) global loss threshold (L^{new}_{global}). At 253, the host system communicates the updated global model (f^{new}_{global}) and the updated global loss threshold (L^{new}_{global}) to one or more local devices including the local device that communicated the local model. At 245, the local device can train the updated global model (f^{new}_{global}).

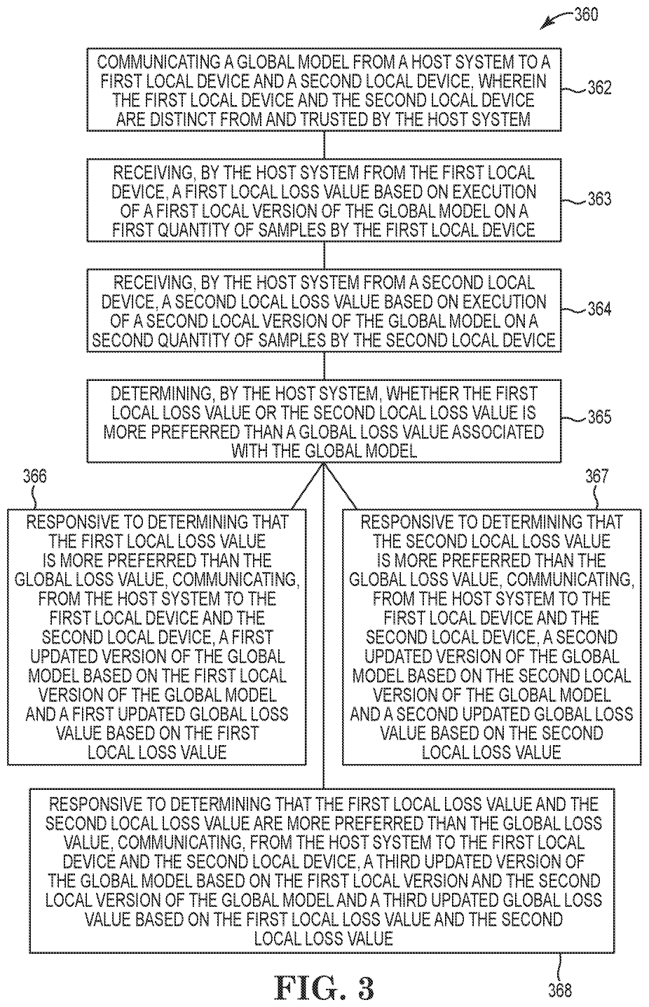

FIG. 3 illustrates an example of a method 360 for federated learning in accordance with a number of embodiments of the present disclosure. The method 360 can be performed by a host system, such as the host system 120 described in association with FIG. 1. The method 360 can be performed by processing logic that can include hardware (e.g., processing device, circuitry, dedicated logic, programmable logic, microcode, hardware of a device, integrated circuit, etc.), software (e.g., instructions run or executed on a processing device), or combinations thereof. One or more processes can be omitted in various embodiments. Thus, not all processes are required in every embodiment. Other process flows are possible.

At 362, the method 360 can include communicating a global model from a host system to a first local device and a second local device. The first local device and the second local device can be distinct from and trusted by the host system.

At 363, the method 360 can include receiving, by the host system from the first local device, a first local loss value. The first local loss value can be based on execution of a first local version of the global model on a first quantity of samples by the first local device. At 364, the method 360 can include receiving, by the host system from a second local device, a second local loss value. The second local loss value can be based on execution of a second local version of the global model on a second quantity of samples by the second local device. The first quantity of samples can be different than the second quantity of samples.

At 365, the method 360 can include determining, by the host system, whether the first local loss value or the second local loss value is more preferred than a global loss value associated with the global model. The host system can determine whether the first local loss value is more preferred than the global loss value based on the first quantity of samples. The host system can determine whether the second local loss value is more preferred than the global loss value based on the second quantity of samples.

At 366, the method 360 can include, responsive to determining that the first local loss value is more preferred than the global loss value, communicating, from the host system to the first local device and the second local device, a first updated version of the global model based on the first local version of the global model and a first updated global loss value based on the first local loss value. The host system can communicate a trust signal to the first local device indicative of the host system requesting the first local version of the global model in response to determining that the first local loss value is more preferred than the global loss value. The host system can associate a time stamp with communicating the trust signal to the first local device. If the host system does not receive the first local version of the global model from the first local device by the time stamp, the host system can determine that the first local device is not trusted.

At 367, the method 360 can include, responsive to determining that the second local loss value is more preferred than the global loss value, communicating, from the host system to the first local device and the second local device, a second updated version of the global model based on the second local version of the global model and a second updated global loss value based on the second local loss value. The host system can communicate a trust signal to the second local device indicative of the host system requesting the second local version of the global model in response to determining that the second local loss value is more preferred than the global loss value. The host system can associate a time stamp with communicating the trust signal to the second local device. If the host system does not receive the second local version of the global model from the second local device by the time stamp, the host system can determine that the second local device is not trusted.

In some embodiments, at 368, the method 360 can include, responsive to determining that the first local loss value and the second local loss value are more preferred than the global loss value, communicating, from the host system to the first local device and the second local device, a third updated version of the global model based on the first local version and the second local version of the global model and a third updated global loss value based on the first local loss value and the second local loss value.

Although not specifically illustrated, the method 360 can include, prior to determining whether the first local loss value or the second local loss value is more preferred than the global loss value, determining, by the host system, whether a respective trust signal from the first local device and the second local device is valid. The host system can determine whether the first local loss value is more preferred than the global loss value in response to determining that the first local device is trusted. Responsive to determining the respective trust signal from the first local device is valid, the host system can determine that the first local device is trusted. Responsive to determining the respective trust signal from the second local device is valid, the host system can determine that the second local device is trusted. The host system can determine whether the second local loss value is more preferred than the global loss value in response to determining that the second local device is trusted.

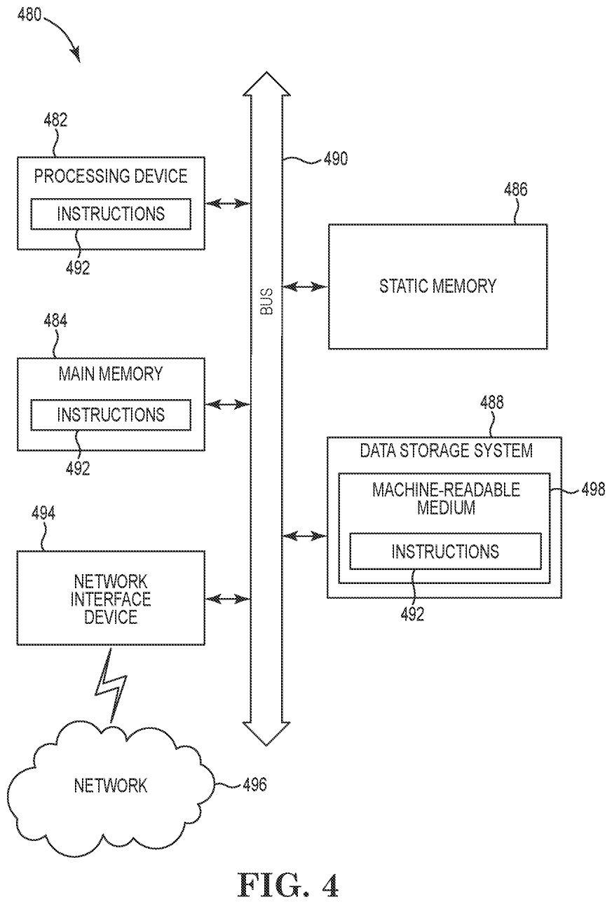

FIG. 4 illustrates an example machine of a computer system 480 within which a set of instructions, for causing the machine to perform any one or more of the methodologies discussed herein, can be executed. In some embodiments, the computer system 480 can correspond to a host system (e.g., the host system 120 described in association with FIG. 1) that includes, is coupled to, or utilizes a local device (e.g., the local device 110) or can be used to perform the operations of a controller. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 480 includes a processing device 482, a main memory 484 (e.g., read-only memory (ROM), flash memory, dynamic random access memory (DRAM) such as synchronous DRAM (SDRAM) or Rambus DRAM (RDRAM), etc.), a static memory 486 (e.g., flash memory, static random access memory (SRAM), etc.), and a data storage system 488, which communicate with each other via a bus 490.

The processing device 482 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 482 can also be one or more special-purpose processing devices such as an application specific integrated circuit (ASIC), a field programmable gate array (FPGA), a digital signal processor (DSP), network processor, or the like. The processing device 482 is configured to execute instructions 492 for performing the operations and steps discussed herein. The computer system 480 can further include a network interface device 494 to communicate over the network 496.

The data storage system 488 can include a machine-readable storage medium 498 (also known as a computer-readable medium) on which is stored one or more sets of instructions 492 or software embodying any one or more of the methodologies or functions described herein. The instructions 492 can also reside, completely or at least partially, within the main memory 484 and/or within the processing device 482 during execution thereof by the computer system 480, the main memory 484 and the processing device 482 also constituting machine-readable storage media. The machine-readable storage medium 498, data storage system 488, and/or main memory 484 can correspond to the local device 110.

In some embodiments, the instructions 492 can include instructions executable by a processing device (e.g., the processing device 482) to communicate a global model to local devices. The instructions 492 can include instructions to determine whether to communicate an updated version of the global model to the local devices based on a respective quantity of samples used by each local device of a subset of the local devices to train the global model and a respective quantity of samples used by each local device of the subset of the local devices to test the respective local version of the global model. Training the global model by a local device yields a respective local version of the global model.

The instructions 492 can include instructions to determine whether to communicate the updated version of the global model to the local devices based on a respective local loss value associated with the respective local version of the global model for each local device of the subset of the local devices. The instructions 492 can include instructions to generate the updated version of the global model based on the local versions of the global model from the subset of the local devices.

The instructions 492 can include instructions to, subsequent to communication the updated version of the global model to the local devices, determine whether to communicate a different updated version of the global model to the local devices based on a respective quantity of samples used by each local device of a different subset of the local devices to train the updated version of the global model and a respective quantity of samples used by each local device of the different subset of the local devices to test the respective local version of the updated version of the global model. Training the updated version of the global model by a local device yields a respective local version of the updated version of the global model. The instructions 492 can include instructions to generate the different updated version of the global model based on the local versions of the updated version of the global model from the different subset of the local devices.

While the machine-readable storage medium 498 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method for federated learning, comprising:
responsive to a valid trust signal from a first local device that is distinct from the apparatus, communicating a global model and a global loss value to the first local device;
receiving a local loss value, an indication of a quantity of training samples, and an indication of a quantity of test samples from the first local device, wherein the local loss value is based on execution of a local version of the global model, generated by the first local device, on a local test dataset by the first local device, wherein the local version of the global model is generated using the training samples;
analyzing the local loss value based on the quantity of training samples and the quantity of test samples; and
responsive to a result of the analysis of the local loss value being indicative of the local loss value being more preferred than the global loss value:
communicating a trust signal to the first local device;
responsive to communication of the trust signal to the first local device, receiving the local version of the global model from the first local device;
updating the global model based on the local version of the global model, the local loss value, the quantity of training samples, and the quantity of test samples; and
communicating the updated global model to the first local device and to a second local device that is distinct from the apparatus.

2. The method of claim 1, further comprising, responsive to the local loss value from the first local device being more preferred than the global loss value, communicating the local loss value to the first local device and to the second local device as an updated global loss value associated with the updated global model.

3. The method of claim 1, wherein the local loss value from the first local device is a first local loss value, and
wherein the method further comprises, in association with the analysis of the first local loss value, determining whether the first local loss value is less than a second loss value from the second local device.

4. The method of claim 3, further comprising, responsive to determining that a third local loss value from a third local device that is distinct from the apparatus is less than the global loss value:
updating the global model based on a different local version of the global model from the third local device and the third local loss value; and
communicating the updated global model to the third local device.

5. The method of claim 4, further comprising, responsive to determining that the third loss value is less than the global loss value:
communicating the trust signal to the third local device; and
responsive to communication of the trust signal to the third local device, receiving the different local version of the global model from the third local device.

6. The method of claim 1, wherein the method is performed by a cloud server.

7. A host system for federated learning, configured to:
communicate a global model to a first local device and a second local device, wherein the first local device and the second local device are distinct from and trusted by the host system;
receive from the first local device, a first local loss value based on execution of a first local version of the global model on a first quantity of samples by the first local device;
receive from a second local device, a second local loss value based on execution of a second local version of the global model on a second quantity of samples by the second local device;
determine whether the first local loss value or the second local loss value is more preferred than a global loss value associated with the global model;
responsive to determining that the first local loss value is more preferred than the global loss value, communicate to the first local device and the second local device:
a first updated version of the global model based on the first local version of the global model; and
a first updated global loss value based on the first local loss value; and
responsive to determining that the second local loss value is more preferred than the global loss value, communicate to the first local device and the second local device:
a second updated version of the global model based on the second local version of the global model; and
a second updated global loss value based on the second local loss value.

8. The host system of claim 7, further configured, responsive to determining that the first local loss value and the second local loss value are more preferred than the global loss value, to communicate to the first local device and the second local device:
a third updated version of the global model based on the first local version and the second local version of the global model; and
a third updated global loss value based on the first local loss value and the second local loss value.

9. The host system of claim 7, further configured to, prior to determining whether the first local loss value or the second local loss value is more preferred than the global loss value:
determine whether a respective trust signal from the first local device and the second local device is valid;
responsive to determining the respective trust signal from the first local device is valid, determine that the first local device is trusted; and
responsive to determining the respective trust signal from the second local device is valid, determine that the second local device is trusted.

10. The host system of claim 9, further configured to:
determine whether the first local loss value is more preferred than the global loss value in response to determining that the first local device is trusted; and
determine whether the second local loss value is more preferred than the global loss value in response to determining that the second local device is trusted.

11. The host system of claim 7, further configured to:
determine whether the first local loss value is more preferred than the global loss value based on the first quantity of samples; and
determine whether the second local loss value is more preferred than the global loss value based on the second quantity of samples.

12. The host system of claim 7, further configured, responsive to determining that the first local loss value is more preferred than the global loss value, to communicate a trust signal from the host system to the first local device indicative of the host system requesting the first local version of the global model.

13. The host system of claim 12, further configured to:
associate a time stamp with communicating the trust signal to the first local device; and
determine that the first local device is not trusted in response to not receiving the first local version of the global model from the first local device by the time stamp.

14. The host system of claim 7, further configured, responsive to determining that the second local loss value is more reliable than the global loss value, to communicate a trust signal from the host system to the second local device indicative of the host system requesting the second local version of the global model.

15. The host system of claim 12, further configured to:
associate a time stamp with communicating the trust signal to the second local device; and
determine that the second local device is not trusted in response to not receiving the second local version of the global model from the second local device by the time stamp.

16. A non-transitory medium storing instructions executable by a processing device to:
communicate a global model to a plurality of local devices; and
determine whether to communicate an updated version of the global model to the plurality of local devices based on, for each local device of a subset of the plurality of local devices:
a respective first quantity of samples used by the local device to train the global model, wherein training the global model by the local device yields a respective local version of the global model; and
a respective second quantity of samples used by the local device to test the respective local version of the global model.

17. The medium of claim 16, further storing instructions executable to determine whether to communicate the updated version of the global model to the plurality of local devices based on, for each local device of the subset of the plurality of local devices, a respective local loss value associated with the respective local version of the global model.

18. The medium of claim 17, further storing instructions executable to generate the updated version of the global model based on the local versions of the global model from the subset of the plurality of local devices.

19. The medium of claim 18, further storing instructions executable to, subsequent to communication the updated version of the global model to the plurality of local devices:
determine whether to communicate a different updated version of the global model to the plurality of local devices based on, for each respective local device of a different subset of the plurality of local devices:
a respective third quantity of samples used by the local device to train the different updated version of the global model, wherein training the updated version of the global model by the local device yields a respective local version of the updated version of the global model; and
a respective fourth quantity of samples used by the local device to test the respective local version of the updated version of the global model.

20. The medium of claim 19, further storing instructions executable to generate the different updated version of the global model based on the local versions of the updated version of the global model from the different subset of the plurality of local devices.
